(19) United States
(12) Patent Application Publication
(10) Pub. No.: US 2003/0160695 A1
(43) Pub. Date: Aug. 28, 2003

(54) Identification and surveillance systems for freight container, and method for the same

(75) Inventor: Atsushi Hisano, San Jose, CA (US)

Correspondence Address: FOLEY AND LARDNER, SUITE 500, 3000 K STREET NW, WASHINGTON, DC, 20007, US

(73) Assignee: OMRON CORPORATION

(21) Appl. No.: 10/119,310

(22) Filed: Apr. 10, 2002

Related U.S. Application Data
(63) Continuation-in-part of application No. 10/080,927, filed on Feb. 25, 2002.

(51) Int. Cl. G08B 1/08

(52) U.S. Cl. 340/539.13; 340/825.49; 340/531

(57) ABSTRACT

The objective of the present invention is to detect, using a universal method, any “movement” inside of the object being monitored while maintaining security of a container. In this surveillance system according to this invention, the communication relay system is used for sensing the movement of the object to be monitored, not for communication purposes as in the prior art. To wit, the object being monitored has nodes (communication nodes) that have communication functions (low-power transmitters), which are attached at various places in the space where the object to be monitored is located. The communication graph matrix represents which node can or cannot communicate with each node. This matrix has the same kind of ID function as a fingerprint for the human, and it can tell whether the container has been kept secure during the time of transportation.

### FIELD OF TECHNOLOGY

The present invention relates to an identification and surveillance system for identifying and surveying freight containers. This system detects abnormalities of the status of an object under surveillance, such as objects loaded in freight containers to be monitored, and also detects if the freight container is illegally swapped with a bogus container loaded with, for example, dangerous explosive materials. This is a continuation-in-part of a pending application which the same applicant filed on Feb. 25, 2002 (the serial number is not yet assigned).

### BACKGROUND OF THE INVENTION

Due to the frequency of terrorist acts internationally, risk management for freight containers being transported on trucks, aircraft, ships, and freight trains has become more important. The possibility exists at a number of places where bombs, poison gas, chemical weapons, radioactive materials or terrorists themselves could be secretly hidden in such freight containers. Further, a wide variety of products or raw materials can be placed in freight containers. Although it is possible in some cases to detect with conventional sensors dangerous materials or the like that have been placed inside of these containers, it is probably the case that such detection is difficult in most cases. Yet another possibility, which does not involve adding dangerous materials to a legitimate container, is to load dangerous materials into a similar, bogus container and then swap containers at some point during transport.

Prior Arts

1) Mechanical Seals

FIG. 9(A) and FIG. 9(B) show the conventional mechanical seal for a container door. The mechanical seal connects the door handle or fixtures so that unauthorized person cannot open the door. The seal can be opened only by a key which only authorized person has. With this kind of mechanical seals, the material of the seal is made by hard metal, and it is difficult to cut the hard metal to open the door. If it could be done, the fact is easily visually detected at a later time. If the cut portion was fixed to conceal entry of the container, the fixed portion is also easily visually detected. It is, however, relatively easy to copy a key and this can lower the security level. This will be a serious problem specially against terrorists bringing dangerous materials into the container.

2) Electronic seals

FIG. 10(A) shows a so-called E-seal, which is an electronic container seal system which allows the shipper to communicate with the container provided with this E-seal. It can be used for high value shipments traveling via ground, rail or ocean. With this E-seal, if an authorized person wishes to open the door on which this E-seal is installed, he has to cut the metal rod or cable. Once the metal rod or cable is cut, an electronic circuit can detect it, and memorize the data in the memory. The data is transmitted to the center when the communication is available. With this system, it is not necessary to check the lock of the container door visually, and it is possible to monitor remotely if the container door is opened or closed. This results in the increase of the number of containers to be checked.

FIG. 10(B) shows another type of electronic seal, a so-called Hi-seal. The Active Hi-G-Seal is a security data-logging device which enables remote reading of recorded events. The Active Seal provides the User instant sealing verification details. Every opening or closing of the seal is logged and can be downloaded to a Handheld Terminal.

The details, logged in the Active Seal and downloaded to the Handheld Terminal include the exact time and duration of the event, putting the accountability for each event in the hands of the party in charge of the sealed object at any given time. The data, collected by the Handheld Terminal is downloaded as a text file for use by standard spreadsheets and databases, for data processing management purposes. The reusable Active Seal is good for 1,000 sealings and its battery can last for several years, depending on the number of readings per day. Once applied the Active Seal cannot be by passed or replicated. The communication between the Active Seal and the Handheld Terminal is encrypted with 3DES encryption, preventing any attempt of duplication.

3) U.S. Patents

U.S. Pat. No. 4,750,197

As shown in FIG. 11, inside of the container, door sensors (38, 40, 42, 44) are provided. A controller is installed in the container, which processes the sensor information to transmit the surveillance and detection signal at the opening/closing of the door, and generates a warning sound. A hole is provided in the ceiling of the container for a lead out of the antenna for a cellular phone and GPS.

With this system, the location of sensors is fixed. If someone breaks a portion of the container wall, which the sensors cannot detect, this system does not work. Although this system is installed inside of the container, the results would be the same as the E-seal installed outside of the container, because the system configuration is apparent by visual observation, and the intruder will devise a way to fool the system easily.

Another problem with this system is that, if the controller and sensors are illegally replaced when the system cannot communicate with the center wirelessly during the time that the door is open, and after the dangerous materials are loaded in, in other words, during the time that the system is changed to the inoperative mode to keep recording, then it is no longer possible to detect the fact that the door is illegally opened or closed. This results in the loading of dangerous materials into the container.

U.S. Pat. No. 5,615,247

As shown in FIG. 12, controller 20 is provided inside of controller 34, and cables 24, and 25 are exposed outside of the container through door gap 33. The cables exposed outside of the container are hanged through door handles 26, 27 and connected to each other by seal 30 for forming a loop which includes controller 20. In order to open the door, it is necessary to open seal 30 or cut cable 24 or 25. Since a controller is provided inside of the container, it has less risk of being attacked by an unauthorized person than the e-seal which is provided outside of the container. Controller 34 can detect the signal indicating one of cables 24, 25, and seal 30 is cut off, and if it happens, then the controller will judge it as an unauthorized door opening, and sends a warning message to the control center wirelessly.

With this system, if cable 24, or 25 are taken off after the handles 26, and 27 are disconnected from the container, controller 34 cannot detect this fact anymore. During such a situation, if dangerous materials are loaded into the container and a new handle is fixed back in place, after cables 24 and 25 are set through, then the controller cannot detect the loading of the dangerous materials. Furthermore, visually the outside of the container will appear to be the same as before, and tampering will not be apparent. As previously mentioned, the weakness of the system is caused by the fact that the security system is apparent visually before the illegal operation is attempted.

Another problem of this system is, the same as the problem in U.S. Pat. No. 4,750,197, that if the controller and sensors are illegally replaced when the system cannot communicate with the center wirelessly during the time that the door is open, and after the dangerous materials are loaded in, in other words, during the time that the system is placed in the inoperative mode the system is unable to record or detect whether or not the door has be illegally opened or closed. This results in loading of dangerous materials into the container.

(Problems of the Prior Arts)

As previously mentioned, since many of the conventional seals are provided outside of the containers, they are easily attacked from the outside of the container. Some of the conventional seals are provided in containers, however the sealing positions are fixed, and they are also easily attacked before the door is opened or closed. In such sealing systems, it is easily observed from the outside. This fact makes it easy for anybody to determine what kind of security systems are in use for the containers, so they can easily make preparations to fool the systems and open the containers illegally. For example, the mechanical seals can be destroyed to open the door, and then later can be replaced by the same kind of seal to fool the security system. For the electronic seals, the electronic circuit can be made inoperative by freezing down to ultra low temperatures to fool it so that illegal opening or closing cannot be detected by the frozen electronic circuit, then the circuit can be reactivated after it. In other words, during the time which the electronic circuit is set sleeping, the door can be illegally opened without being detected.

Another problem is that mechanical keys are used in the mechanical seals by authorized personnel, and pass words are used in the electronic seals. If a terrorist sends their fellows to the container operating company who uses such mechanical or electronic seals, the mechanical keys and the passwords are easily leaked by them, and thy can easily open or close the door legally. In such a case, both types of seals do not work for security purposes.

Further, the mechanical and electronic seals protect or monitor only if the door is opened or closed. The container is constructed of steel or aluminum, and the side plate, ceiling plate, or the floor plate can be drilled to be opened, or a hole can be made by a burner or laser beam. The containers must be, therefore, protected from these kinds of attacks.

Yet another problem of the prior arts is that they may be able to help preventing illegal opening or closing of a container door, but they can detect such evidence only after the container is moved into a container yard at a destination port. it is not possible to detect such illegal opening or closing of the container door before the container arrives into the territory of the United State.

### SUMMARY OF THE INVENTION

The first objective of the present invention is to detect, using a universal method, any “movement” in the object being monitored while maintaining security, which is not dependent on what kind of sensors are used.

The second objective is to provide the capability of detecting the substitution of an object being monitored, such as swapping an object.

To achieve the above objectives, a concept of an “inside-seal” is used in this invention. The basic ideas of the “inside-seal” are concentrated as follows:

1. The inside-seals for sealing a container are provided inside of the container so that they cannot be observed from the outside of the container. This arrangement can prevent terrorists from pre-arranging the illegal opening and closing a door of the container, or freezing the electronic circuit to fool the detection function for detecting opening and closing the door.

2. If the inside-seal is provided at a fixed position inside of a container, it is still not difficult for terrorists to fool the seal, the inside-seals of this invention are provided basically at the random positions in a container.

3. The password for opening and closing a door according to this invention is automatically generated at a surveillance center which is separated from the container operating companies. It is because, if a partner of terrorists is in the container operating company, he may be able to steal the password for illegal opening and closing of the door. This arrangement can prevent such illegal operation.

4. If the inside-seal provided in a container is attacked, or an illegal opening or closing of the door is detected, then the “electronic fingerprint” recorded in the container, which corresponds to the electronic fingerprint recorded in the surveillance center, is deleted automatically. Since the electronic fingerprint was randomly generated, it will not be possible to regenerate an identical electronic fingerprint. When terrorists prepare a bogus container to swap with a true container, it would not be possible to copy the true password because the true password has been deleted. This arrangement can detect the bogus container. When it happens that the container cannot detect the illegal opening or closing of a door to the surveillance center wirelessly, this function can still identify the container which has been attacked by requesting the display of the electronic fingerprint.

5. Not only detecting the illegal opening or closing of the door, the surveillance system, according to this invention, can detect whether or not dangerous materials have been inserted through a hole made by a drill, burner, or laser beam, and if an illegal person has entered the container.

6. In order to prevent dangerous containers entering into the USA before they enter into the USA, maybe during a transportation by a container ship, the surveillance system according to this invention makes it possible to detect such illegal loading into a container during the container is still on a board of a container ship, and send a warning signal to a surveillance center, so that the surveillance center can notify such a fact to the coast guard before the container arrives to the destination port.

In order to make the inside-seal discussed above applicable, the following two inventive thoughts are utilized in this invention.

The present invention is applicable to a wide variety of objects of surveillance, automobiles, containers, homes, factory machinery, etc for surveillance purposes. Among them, the resolution of the problems of the prior art will now be described mainly with reference to cargo containers.

Two Types of Dangerous Containers

1)The detection of dangerous materials is likely to be affected by such factors as how the cargo is loaded, the type of material of the dangerous article, and its packaging. Thus, rather than designing a conventional sensor appropriately to detect dangerous materials according to the properties of such dangerous materials, the method for detecting any “movement” which would occur during the act of secretly hiding dangerous materials in the container, would be a universal detection method for detecting abnormalities that are unaffected by the nature of the dangerous material being detected. Considering that detecting the “movement” of containers having various structures, and made from various materials, rather than detecting the dangerous material itself, the greater universality would be achieved by attaching a communication network, having one or more communication nodes in the container which communicate with each other, to thereby detect “any movement which may occur between the communication nodes”, a method that is unlikely to be influenced by any of the materials or structure of the container.

2)There is also the possibility that rather than dangerous material being secretly hidden in a container, that a bogus container, holding dangerous material, could be switched with the original container. In order to handle this type of container swapping, it would be necessary to affix some specific information to the container, comparable to identifying by a human fingerprint or voice print, that is also registered in the surveillance center, and then by comparing the information affixed to the container with that registered in the center, it would be possible to detect any swapped, bogus container. To implement this, the specific information affixed to the container and its registration at the center should be handled automatically without human intervention, because people frequently leak specific information such as passwords.

Based upon the foregoing analysis, the following is an ideal means of addressing this problem.

The object, such as a cargo container, being monitored by a surveillance system according to this invention would be equipped with one or more communication devices provided in the container, that would communicate with a plurality of communication nodes. According to this invention, it is possible to detect the “movement of communication nodes distribution” which has occurred by the movement of an object, which is being monitored, because the movement of an object will interfere with the communication nodes distribution. From the detected “communication nodes distribution”, therefore, it is possible to obtain the characteristic status information which can identify the object being monitored. This is a main feature of this invention.

The movement between the communication nodes, and the movement of the object will be explained as follows. In “movement”, there is a deformation in the configuration of the object being monitored, and a displacement in a portion of the object (e.g., the opening or closing of the container door, somebody stepped into the container, or something was loaded into or out from the container, etc.).

According to the deformation as described above, the communication relay system mentioned above is used for identification and surveillance systems, for sensing the deformation of the object to be monitored, not for communication purposes as the prior art U.S. Pat. No. 6,028,857. To wit, the object being monitored has nodes (communication nodes) that have communication functions, (low-power transmitters), which are attached at various places in the space where the objects to be monitored are located, such as inside of a container. Each of these communication nodes communicates to generate the information of communication nodes, distribution nodes, which is a characteristic of the spatial status of the nodes. This spatial status of the nodes, namely the information of communication nodes distribution, can represent the current status of the object to be monitored. For example, a certain communication node is selected as the central node, then the distance to the other nodes from that central node is determined by calculating the relaying times it takes for the communications from the nodes to arrive at the central node, and that information is reported to the central node. Thus, the specific information for the various nodes may be able to represent their respective communication distances from the central node. Further, it is possible to determine communication node coordinates by knowing the number of communication nodes and measuring the communication distance from each of these communication nodes to the base nodes, and to then determine the coordinates of the communications nodes by the intersection points of circles or spheres that use those measured distances as radii.

Yet another way would be to not establish a central node or any base nodes, but to have each of the communication nodes detect their own communication distance to respective other communication nodes (which could be done through a code expressing whether or not direct communication was possible, by establishing the number of communication nodes, which were required to communicate with another communication node, by computing based upon the transmission power requirements for the signal to achieve direct communication, (or by computing the signal arrival time), and to assemble all of the detected distances to generate specific status information on the object. Thus, as far as the information of communication nodes distribution is specific to the object to be monitored, or if unique numbers are assigned to the communication nodes specific to the object, these can be specific status information that is required to identify the object.

One way to detect the distance from each node to the other nodes as discussed above is disclosed in U.S. Pat. No. 6,028,857 of a communication network provided with a self-organizing network. This self-organizing network is a kind of a relay system to communicate between a plurality of nodes, each of which has a low-power transmitter for saving the battery power. This low-power transmitter can communicate only with the neighboring nodes which are located only a few meters away for the purpose of saving the battery power. The details will be explained in the flow chart, which will be explained later.

### BRIEF DESCRIPTION OF THE DRAWINGS

FIG. 1 shows the system structure for an embodiment of the surveillance system 1000 according to this invention.

FIG. 2(A) shows a network graph showing a link established between the communicating nodes before the door is opened.

FIG. 2(B) shows a network graph showing a link established between the communicating nodes after the door is opened.

FIG. 3(A) shows an initial network graph matrix corresponding to the network graph in FIG. 2(A).

FIG. 3(B) shows a network graph matrix corresponding to the network graph in FIG. 2(B), which is changed by opening the door.

FIG. 4 shows the overall processing flow to form the network graph matrix among the communication nodes in the communications network.

FIG. 5 shows a process flow in each communication node in the network of this surveillance system.

FIG. 6 shows a process flow in the control device showing how the control device communicates with other devices outside of the container in the surveillance system,

FIG. 7 shows a water proof cap used in this invention.

FIG. 8 shows how to fix an antenna on a mechanical lock provided outside of a container.

FIG. 9(A) and FIG. 9(B) show mechanical lock device according to the prior art.

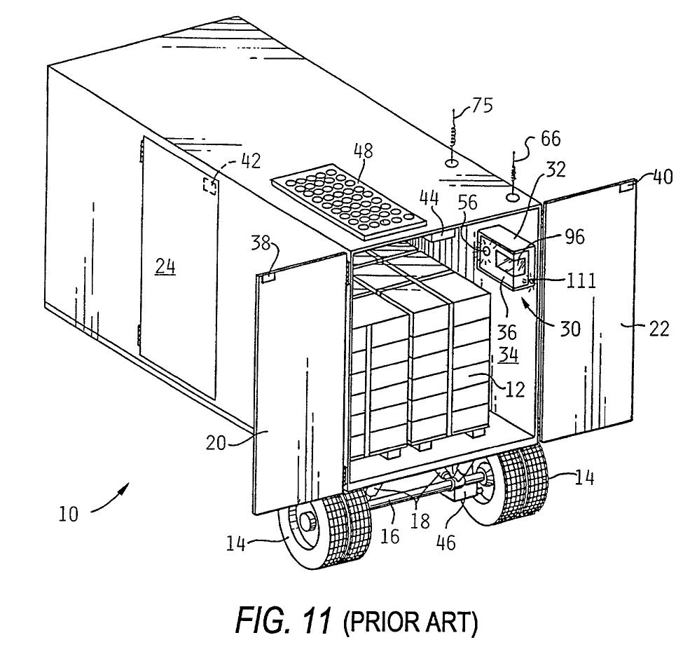

FIG. 10 (A) and FIG. 10(B) show electrical lock systems according to the prior arts.

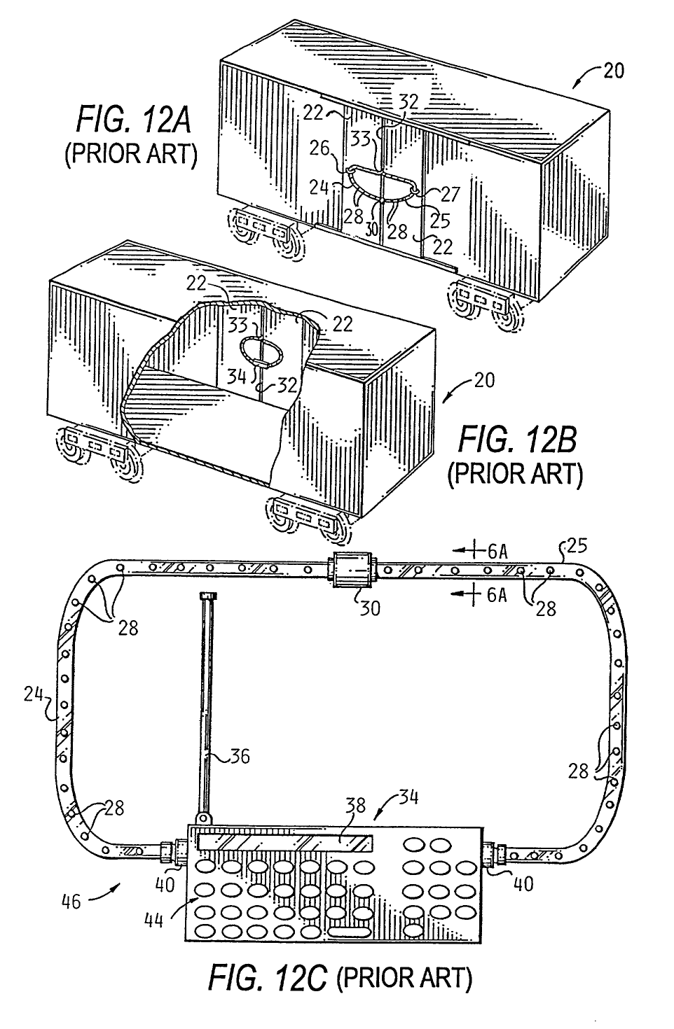

FIG. 11 shows a rough sketch of a prior art shown in a United State Patent FIG. 12 shows a rough sketch of a prior art shown in another United State Patent FIG. 13(A) and FIG. 13(B) show a container wall of a container made by a folding metal.

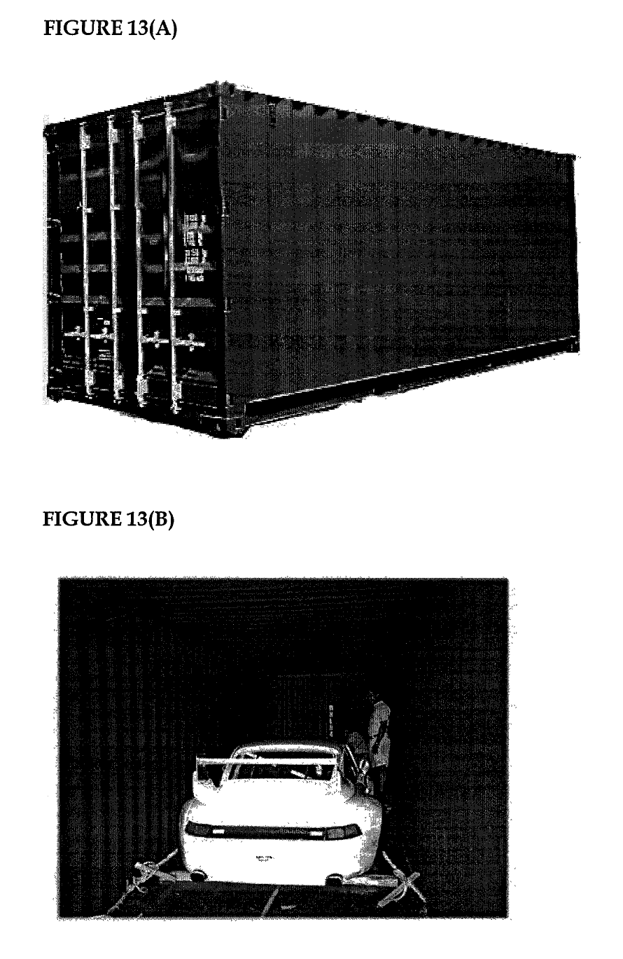

### DETAILED DESCRIPTION OF THE INVENTION

The information of communication nodes distribution generated by the communication nodes installed upon the object being monitored can represent a movement of the object, and also it can be status information to identify the object, if the communication nodes distribution is specific to that object, or the numerical data assigned to the specific object is specific. This principle is applied in the following embodiment of this invention.

As mentioned above, this invention can be applied to the security of freight containers. The containers are conventional types having a structure which is standardized internationally, but this invention can be applied to any container, and further it can be used for any mobile container, and even house security applications.

The subject container is such that it may be loaded or unloaded interchangeably on conveyances such as freight trains, trucks, cargo ships, and aircraft, and it is equipped with fixtures that facilitate its raising or lowering by loading equipment. In addition to being strong enough to accommodate stacking, it is constructed to prevent slipping when stacked. Further, it may have a door or lid to accommodate lowering or stacking cargo into the container.

Definition

In this specification, the following definitions will be applied.

1) Communication Node:

Communication node is a node in a communication network. In the self-organizing wireless network which is applied in the following preferred embodiment, the network comprises a plurality of communication nodes, each of which communicates with other nodes.

2) Communication Device:

A communication device is a device having a communication function and a memory function. This can be one of the communication nodes in the network. In the preferred embodiment, the communication device can function as one of the nodes which form the self-organizing wireless network.

3) Information of Communication Nodes Distribution, or Distribution Information:

This is the information on how the nodes are located in a space. It can be defined by position coordinates, by the relaying times for communicating between the nodes to each other, also by distance. It can also be defined by whether or not the communication carriers (radio wave, beam, sonic) can reach the receiver. In the preferred embodiment employing the self-organizing wireless network, can create a HOPs table at each node.

4) Status Information of the Object

The status information of object is an information indicating at least one of deformation of the object to be monitored, position of the object, and communication circumstance around the object to be monitored. In the preferred embodiment of the self-organizing communication network, a network graph matrix is the status information of object.

Overall Configuration of the Surveillance System of this Invention

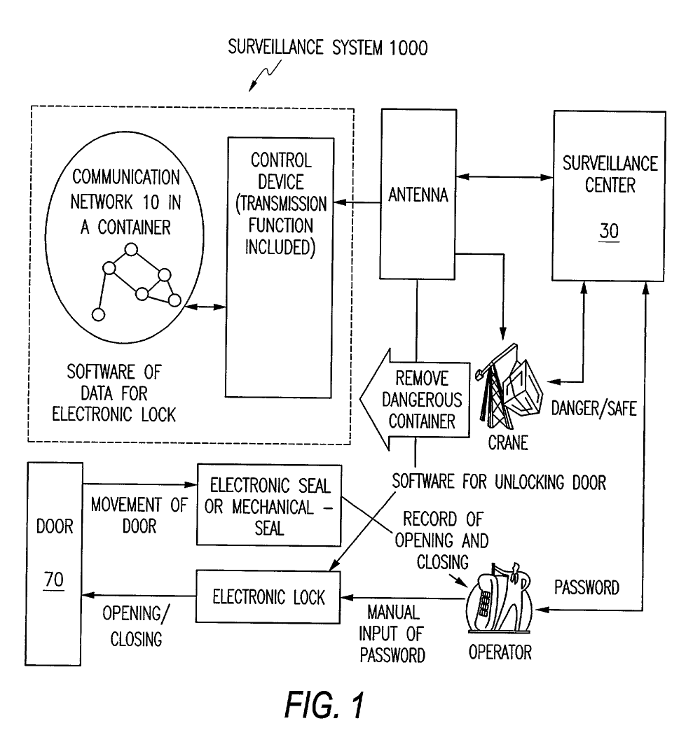

FIG. 1 shows the system structure for an embodiment for the surveillance system 1000 according to this invention. The container 1 is equipped with a variety of electronic devices in a conventional container. A communications network 10, which will be described in detail below, has been established inside container 1. Communication nodes, which have wireless communications capabilities, have been attached inside of the container to the door, walls, and cargo to form the communications network 10.

Installation of Sensors

The inside of the container is a difficult to wire with cables. As shown in FIGS. 13(A), and 13(B), the inner wall is bellows shaped, and it is made with a folding metal. This configuration of the wall makes it difficult to fix cables along the wall. If the cabling is fixed over the inner folding wall, the cables are easily damaged when the cargos are loaded in and out. It is, therefore, necessary to fix the sensors within the ditches of the folding wall by adhesive or bolts, and send the sensing data wirelessly to the control device to eliminate the wiring in the container.

Further, since the wiring environment in the container is not good, if the sensors are needed to be installed at the specific positions on the wall, the installation cost of sensors will become high. The installation position of sensors can be random not only because of the installation cost, but also because it is better for forming the higher security system. It is, therefore, necessary to have flexibility to select the installation position for the sensors in the container. As mentioned above, for forming a communication network in a container which collects the sensing data from sensors which are installed at random positions, and sends them to the control device, the communication network is needed to have a self-organizing network function which will be explained later.

Sensors

Further, the container walls (side plate, ceiling, door, and floor) are made with aluminum or steel, and it is possible to make a hole by a drill or burner. Specially since the recent containers are built lightly, it is easier to make such holes than in the previous types of containers. It is, therefore, necessary to detect such activity other than only to detect the opening or closing of the door. In order to detect the action of making a hole on the side plate, ceiling, door, and floor of a container from the outside by a drill, burner or laser, it is necessary to install vibration sensors and temperature sensors on the wall.

One of the examples for vibration sensors is model D7F-C01 made by Omron Corporation. This type of vibration sensor can be modified to meet the temperature range for such purposes. It can be selected from the sensors which are relatively thin so that they can be installed within the ditches of the folding wall. A thin vibration sensor is disclosed in the Japanese patent publication Hei 6-162353 (made by Omron Corporation). The thickness of this sensor is relatively thin, and it can collect the vibration of the container wall by the bottom base which is attached to the wall.

Temperature Issues

The temperature in a container is varied between −30 degrees C. and +80 degrees C. For the sensors and the communication nodes (the details will be explained later). It is necessary, therefore, to install a battery, micro computers, and the peripheral circuit which can be operable for a long period in a variety of temperature ranges. One of the examples is model BR2477A (high temperature resistant type fluoride black lead lithium battery) made by Matsushita Electric Works. The operable temperature range of this battery is between −40 degrees C. and +125 degrees C., and the output voltage is 3V.

One of the examples of the micro computer is series M32R/ECU made by Mitsubishi Electronics Company. The operable temperature range of this micro computer is between −40 degrees C. and +80 degrees C., and the power voltage is 3.3V.

If this micro computer is kept activated continuously by the battery of BR2477A, the battery will be consumed in a short time. It is, therefore, necessary to supply the electric power in the interval time period to the communication nodes, the control device, and the sensors connected to them, all of which use micro computers. This interval time can be controlled by a low power time circuit. The temperature range of the communication nodes, the sensors and the control device must be set wider, and the battery having a wide temperature range must be used in the system according to this invention. Some of the communication nodes are provided with vibration sensors to detect any drilling for making a hole in the wall. The communication nodes can also be provided with the temperature sensors to detect burner heat for making a hole in the wall.

Communication Nodes

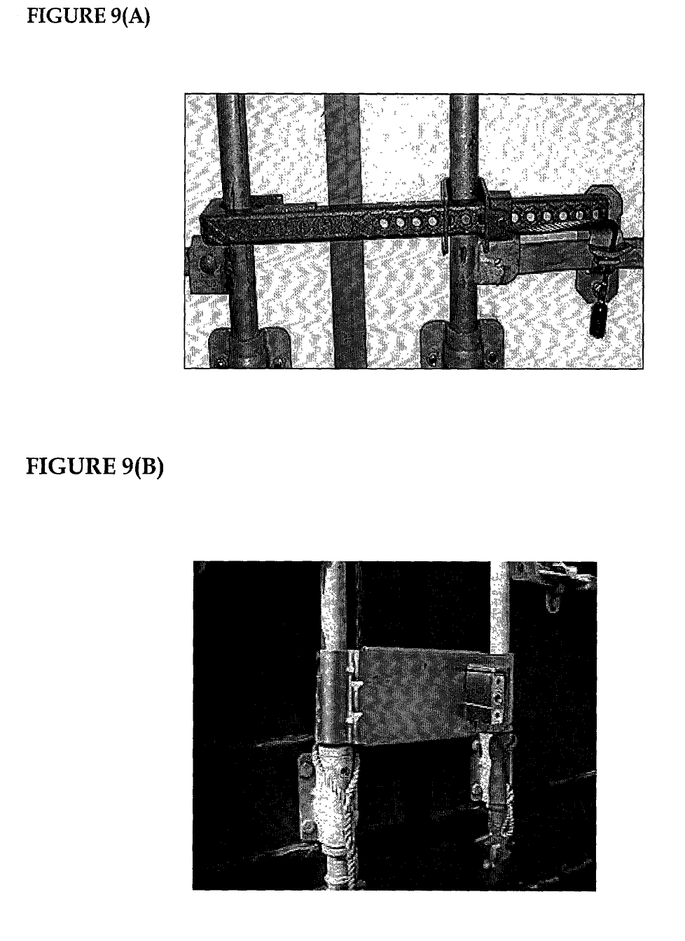

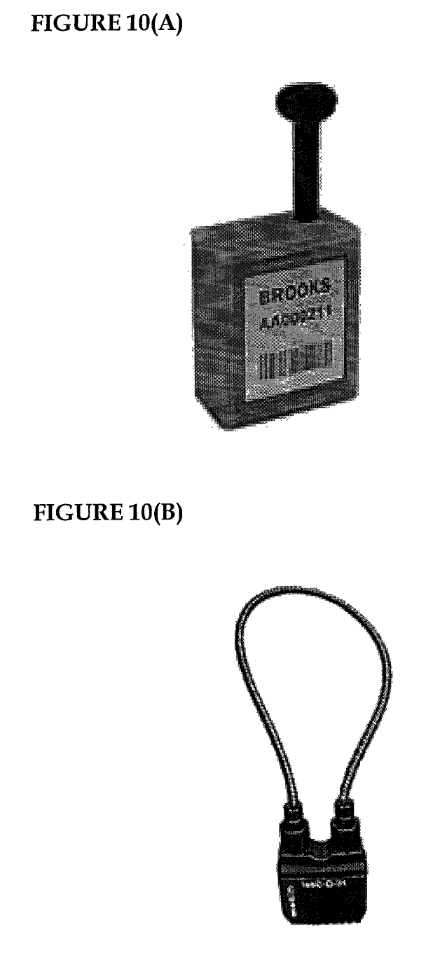

As shown in FIG. 8, the communication nodes 801 are fixed at a random position on the inner wall of the container. In order to detect the opening or closing of the door of the container, at least one communication node must be installed in each door, and the distance between the nodes must be within the range in which mutual communication is possible. A connecting cable from the control device and an antenna 820 is lead out to the outside of the container through the gap formed between the doors. The water sealing shown in FIG. 7 is provided between the gap to prevent water leaking into the container. As shown in FIG. 8, there are 4 rods 830 at the front side of the door. Between the central pair of the rods, each of which is provided on each door, a conventional mechanical seal is provided to seal the closing door, which was discussed earlier. The antenna 820 is fixed on the seal, and the antenna cable is connected between the antenna provided outside of the container and the control device provided inside of the container.

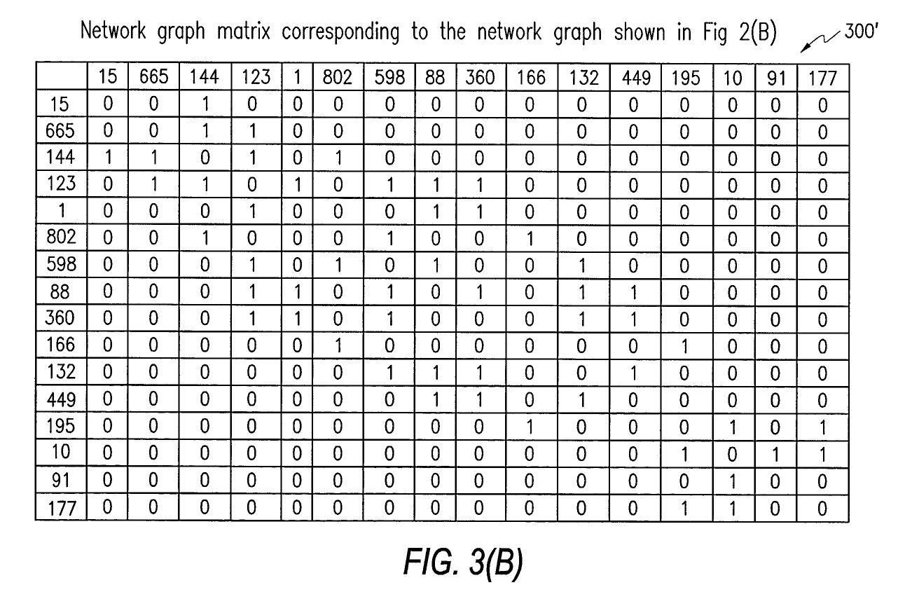

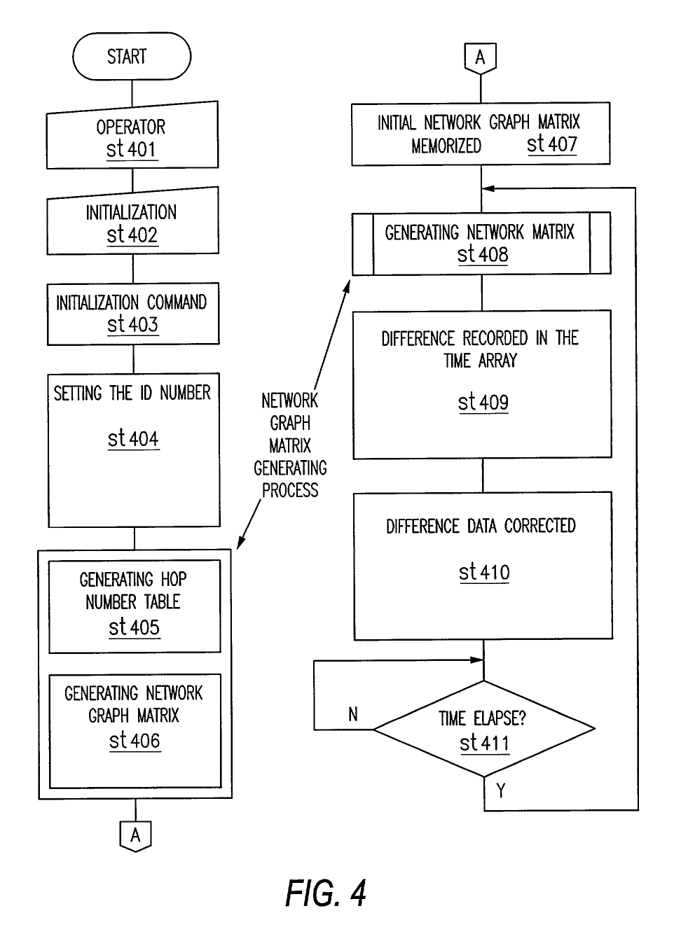

Communication nodes 801, which have wireless communications capabilities, are attached inside of the container to the door, walls, or the lorded cargo to form the communications network 10. At a specified time interval, this communications network 10 generates a network graph matrix which expresses an information of communication nodes distribution in the communications network 10. The first network graph matrix generated right after the door is closed will be a unique information of the container which is loaded with the cargo. An example of the network graph matrix is shown in FIG. 3(A). FIG. 3(B) shows the network graph matrix after the door is opened. These matrixes will be explained in detail later.

Control device 20 for container 1 is located inside of the container, and it functions as one of the communication nodes, which communicates wirelessly with the various communication nodes in the communications network. Upon receiving a specific command from the control device, all of the nodes in the communications network provided in the container to be monitored can self-organize for forming a communication network within the container, and reports out it's own network graph matrix resulting from self-organizing to the other communication nodes. In other words, all of the nodes will share the same information of the network graph matrix, which can make the system difficult to alter illegally as will be discussed later. When the control device 20 issues a command for the communications network 10 provided inside container 1 to initialize, the communication network 10 generates the initial network graph matrix, which will be memorized by each communication node. Accordingly, the control device 20 also memorizes the initial network graph matrix. The control device 20 has wireless transceiver capabilities, and it is connected to an antenna cable which extends to the outside of the container through a small gap between the doors. The antenna cable is connected to the antenna provided outside of the container. Through the antenna, the control device 20 can communicate with the surveillance center 30.

When the loading of the container has been completed, the control device 20 sends a command to the communications network 10 to generate the initial network graph matrix 300. This command is received by control device 20 from an outer commanding device through the antenna. The example of a network graph matrix is shown in FIG. 3(A). When each node receives such a command, each node will generate the initial network graph matrix which represents the distribution information of the communication nodes communicating with the other nodes. When control device 20 receives the graph network graph matrix, then the control device 20 will wirelessly send the matrix data to surveillance center 30 as an initial network graph matrix. Surveillance center 30, records this information in memory as the characteristic information for that container which will be used to identify the status of container 1.

Verification of Container

Next, the verification processing that takes place when container 1 reaches its destination will be described. When the container reaches its destination, it is first grasped, suspended and moved to the container yard by a crane according to the conventional freight transportation system. Prior to the container being moved by the crane or during it's moving, the following information is read out from control device 20 of container 1.

1) Initial network graph matrix 300, location and time information at the time of the notification as well as the container's control number,

2) History data of the network graph matrix

The crane, which has the capability of reading and acquiring the foregoing data

1) and 2) or has the intelligence function of receiving such data from surveillance center 30, can make a determination that this is a dangerous container prior to lifting it, if it is unable to read out the data because of an alteration of the system which might have been done illegally by somebody having no authority( or if all data recorded in the control device 20 has been deleted). If it succeeds in reading out the data, it then transmits the data to the surveillance center if it is not yet reported to the center. At surveillance center 30, that data is compared with the previously registered data which was acquired at the time the container was sealed and shipped out. In the case where there is no match as a result of the comparison of the network graph matrix, acquired at the time the container arrived at the container yard, with the information that was recorded at the surveillance center, the surveillance center makes the decision that it is a dangerous container and notifies the crane for special attention.

Further, if, as a result of the comparison of the initial network graph matrix with the acquired history data of the network graph matrix, for example, if the history data of the communication nodes attached to the container door 70 had deviated substantially from the initial network graph matrix more than a predetermined value, then the surveillance center makes the determination that it is a dangerous container due to improper opening/closing of the door 70. In such a case, the surveillance center 30 would notify the crane that the container is dangerous. The crane can then deal with any containers that have been determined to be dangerous, such as by moving them to a special area. In the surveillance center, it is necessary to know which links of the nodes are related to the open/close of the door from the network graph matrix. In order to know this, each of the communication nodes at the door are arranged relatively closer, and the nodes at the counter wall of the container are arranged relatively far from the nodes at the door and separately from each other. With this arrangement, the relaying transaction between the nodes at the door is more frequently done than other nodes. Since the surveillance center can easily detect such frequent relaying data by analyzing the network graph matrix, it is possible to identify the specific nodes which are related to any change if the door was illegally opened.

Of course the comparison of the network graph can address any portion in the container, it will be able to detect any deviation of the status in the container, such as a deviation caused by missing cargo or, on the contrary, adding of cargo, especially dangerous cargo.

When container 1 is moved into the container yard, and the door of the container needs to be opened, since container 1 according to this invention is equipped with an electronic lock 60, the door cannot be opened without a password. The password for this container 1 is automatically generated at surveillance center 30 based on the initial network graph matrix, at the time and the position of the time of the notification. The surveillance center 30 then downloads the electronic lock software or data to the electronic lock via the control device. Optimally this download should take place only after the container has arrived at its destination and its safety has been confirmed. After the download has taken place, surveillance center 30 then can wirelessly notify the person having authority to receive the password to open the container door (the consignee, custom officers, etc.) by cellular phone or other separate safety route. Since the password originally was generated based on the configuration of the initial network graph matrix, the downloaded software does not open the door unless the received password corresponds to the initial network graph matrix. Only when such a condition is satisfied, can the person who receives this password notification open the container door. Thus surveillance center 30 is able to control who is able to open the container door by the foregoing means.

Linkage Between the Nodes

Next, the communications network 10 installed inside of the container will be described. A plurality of nodes (communication nodes) having communication capabilities are disbursed and attached to the inside of the container's walls and doors. It is also possible to attach the nodes inside of the loaded cargo. These communication nodes communicate with each other to generate the distribution information of nodes by communicating with each other between the nodes, and they will self-organize communication network 10. An example of such a self-organizing network is disclosed in U.S. Pat. No. 6,028,857.

According to this invention, each communication node has at least the capabilities as set forth in 1 through 4 below.

1. ID memory capability

2. Wireless communication capability to communicate with the neighboring communication nodes

3. Self-contained battery power supply

4. The capability of memorizing the HOP number table, which relates to all of the communication nodes in the container and the number of communication HOPs it takes to communicate with each node via the neighboring communication nodes.

As an option, if the communication nodes have the below-listed capability 5, the communications network also becomes a sensor network.

5. A sensing capability for the local status around the communication nodes (e.g. acceleration, vibration, temperature, the concentration of a specific gas, etc.). For sensing the local status, conventional sensors can be attached to the communication nodes.

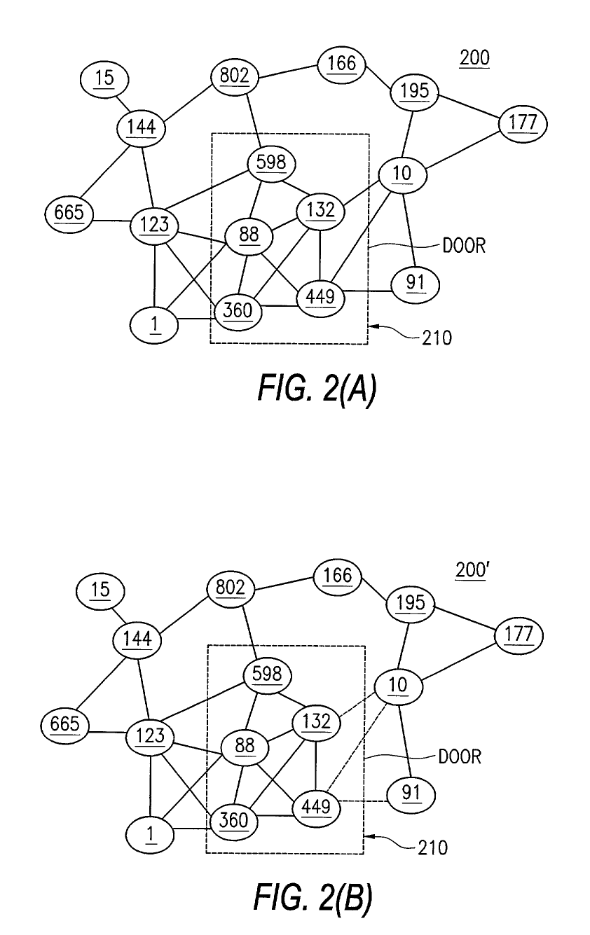

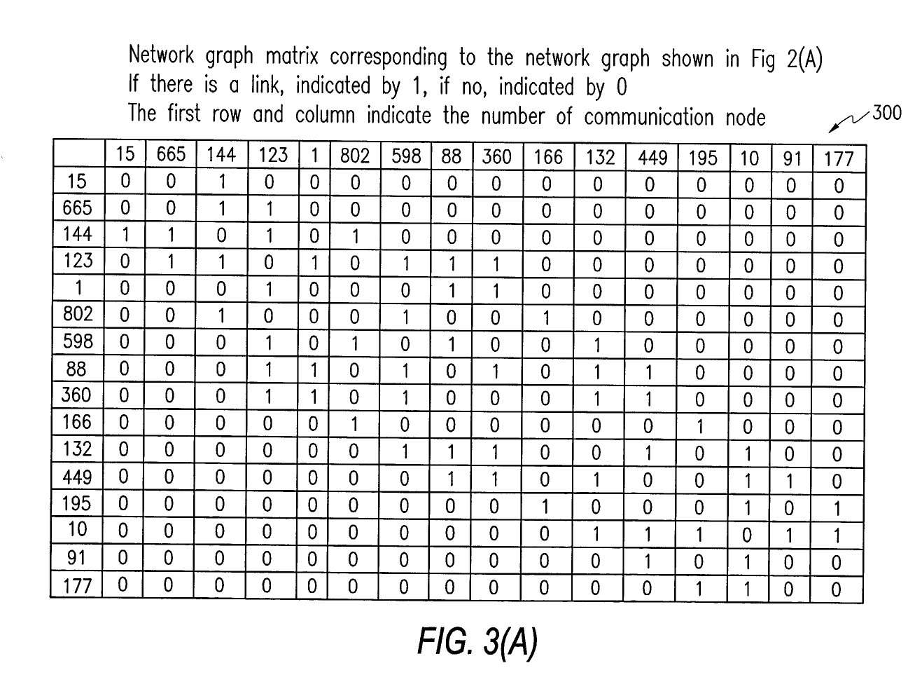

In order to conserve electric power, and express the relative spatial distribution of the nodes in the space where the object to be monitored is located, the communication nodes are set to communicate with each other with a weak signal, which enables them to communicate among themselves over communication links. This weak signal can be made with radio wave, acoustic wave, or light beam. As a result, this means that each communication node can only communicate with adjacent or neighboring nodes. Communication with distant nodes takes place only by relaying through the intermediate nodes. To wit, each communication node functions only if the electric field strength of the message from the other communication node is above a certain level. When the electric field strength of a message from another communication node is above a predetermined level, a link is established between the communicating node and the receiving node. This establishment of links between communication nodes is shown in form in FIG. 2(A). This is called a network graph 200. In this graph, if the nodes are linked with a single line, it means they are within the distance, or the status to communicate directly. If there is a link between node p and node s, the value of 1 is set, and if not, the value of 0 is set. When such value setting is done between all of the nodes shown in the network graph, the initial network graph matrix 300 is formed as shown in FIG. 3(A). In FIG. 3(A) and FIG. 3(B), row 1, column 1, represents the ID numbers of all of the communication nodes shown in network graph 200 shown in FIG. 2(A).

From this initial network graph matrix 300, it can be understood that, for example, there is a link between node 144 and 802, but no link between node 144 and node 598, because each of the nodes are communicating with each other only with a weak signal which reaches only the neighboring nodes.

Next, the method for detecting container abnormalities or status changes by using the communications network 10 installed inside of container 1 will be described. FIG. 2 (A), for example, shows the links established among the large number of communication nodes inside the container. The group of communication nodes 210 enclosed by the broken line are those installed on the door 70 {598, 88, 132, 360, 449}. These numbers represent the ID number of each node. When the container door is opened or closed, the link status with the other adjacent communication nodes {10, 91} will change because of the movement of the door, and the links between these nodes are disconnected.

For example, in the case of an out-swinging door with its supporting hinge located in the area of the communication nodes 88 and 360, communications will cease over the following link groups when the door is opened and the distance increases between communication nodes resulting in the network graph 200′ as shown in FIG. 2(B).

Link (132,10)

Link (449,10)

Link (449,91)

Also, if the door were a sliding door, conversely, new links also would be formed as the distance of the communication nodes near the sliding door may became closer.

The surveillance system according to this invention is not confined to just the opening and closing of the container door. A person who wanted to introduce dangerous material into a container could, for example, skip the closed door and use the ventilation openings or remove a side plate from the container to insert the dangerous material into the container. In such cases as well, there would be a change in the link relationship among the communication nodes. The deformation in the link relationship will show up as the deformation of the network graph matrix 300′ as shown in FIG. 3(B) where the indications of “1” are changed into “0” between nodes 132 and 10, 449 and 10, and 449 and 91.

If the door is a sliding door, it can happen that the nodes previously located a certain distance from each other is changed to a closer position in which a linkage can be established between the nodes.

The detecting portion is not limited to a door. It could happen that an illegal thief could go into the container through the ventilator or side plate to insert dangerous materials, but not through the closed door, or he may insert dangerous material into the container through the same. In such cases, the evidence of such an illegal operation will be shown as a deviation or change in the network graph matrix.

Any deviation in the current network graph matrix from the previous network graph matrix that was generated at the time when the door of the container was closed, following the loading of the cargo, indicates the possibility of a container abnormality.

Communication Between the Containers Stacked on a Container Ship

Each container which is provided with a surveillance system according to this invention is equipped with an antenna extending to the outer side of the container. Many containers are loaded and stacked one on top of another on a container ship. The side wall of each stacked container is lined up almost without any space between the other containers. Each container door has, however, some space so that the door does not contact any of the next containers which are lined up.

There is, therefore, some open space between a container door and the rear wall of a container, and the neighboring containers. In some cases, the open space is not large enough for a person to go into in order to open the door and drill a hole in the wall of the container. Even in such a loading configuration, however, it is possible for a man to access the top ceilings of the containers which are stacked on the upper-most top of the stacked container mass on the container ship, and also possible to access the side walls or doors of the containers which are lined up at the most outside of the stacked container mass.

Among the loaded containers, there are many containers on a container ship, which are accessible by a person or a terrorist. For these types of accessible containers, it is possible to communicate wirelessly with an antenna of the container ship via the door antenna attached on each container door.

On a realistic container ship, however, most door antennas provided on the container doors are not located at the point from which it is possible to visually access the antenna of a radio device of the container ship. It is, however, still possible for all of the containers to communicate with a computer installed in the container ship, if a door antenna of a container stacked at the edge of the mass is located at a position where it is possible to observe one of a plurality of antennas provided at equal distances apart on a deck fence, which is installed for the avoidance of the crew members falling into the sea.

It is because the container can communicate with the neighboring containers located at the upper, lower, right, and left positions of the container, that they can form a self-organizing communication network. This arrangement can be formed on each line or row of the stacked containers on board the ship.

For each line or row of containers, an antenna located at the end of each line or row of the containers can form a communication link with the radio device on the deck fence.

Furthermore, each radio device distributed along the deck fence can function as a communication node, and automatically form a communication link with each other. As a result, each control device in a container functioning as a communication node which is provided with an antenna extending out from each container, a radio device provided on the deck fence, and a radio device provided in the radio room of a container ship, all of these three devices can form a self-organizing communication network as a whole.

Consequently, all of the containers loaded on a container ship can communicate with the radio device in the radio room of the container ship relaying the messages from the other communication nodes. With this arrangement, each container can notify the radio device in the radio room of the status of each container. It is then possible to survey whether or not the door has been opened or closed, and if it has been drilled.

As a result, for example, it becomes possible to notify the Coast Guard of any abnormal event in the loaded containers before the container ship arrives into the territory of the United States.

Flowchart for Identifying the Original Container

Next, the way of using the communications network inside the container to establish that the container's status is the same as the original, will be explained.

Detecting that no substitution of a bogus container has taken place, is very important for identifying the original container, and for using the electronic lock for opening and closing of the container door. Conventionally, a container password simply corresponding to the container's serial number is devised by humans. However, the biggest problem with this method in the past is that the password and the container serial number were simply unrelated data to the unique properties of the container. Accordingly, it was possible to make a substitution by switching the ID and the corresponding correct password of another container.

In order to protect from such illegal handling of the container, the network graph can be a detection tool to detect such illegal handling, because the network graph or network graph matrix which is generated at the time of the closing of the container indicates unique properties of that container, and the network graph matrix is generated automatically without any human intervention. If a person deliberately tried to alter the network graph matrix, this action would be detected easily by comparing the present network graph matrix with the original network graph matrix data.

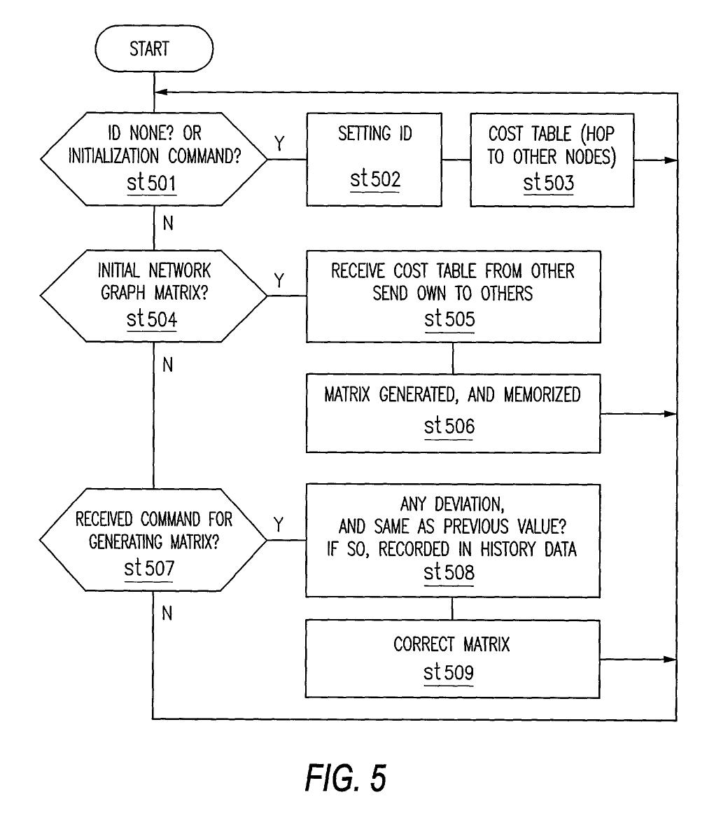

FIG. 4 shows the overall processing flow to form the network graph matrix among the communication nodes in the communications network which is a part of the surveillance system 1000 according to this invention. The flowchart in FIG. 4 is addressing how the user of this surveillance system can initialize the system.

In st401, an operator installs communication nodes inside container 1. These communication nodes are small devices provided with a transmitter for weak signals and a receiver for receiving such weak signals from the neighboring nodes. Then, in st402 the operator gives the initialization command for control device 20. Control device 20 can be one of the nodes, or an independent dedicated device. In st403, control device 20 issues the initialization command to all of the communication nodes. Since the nodes have not yet been assigned node numbers, the control device sends the initialization command, with relatively big power, to all of the communication nodes so that they can initialize all at once. In st404, each communication node sets its own ID number using a randomly generated number (the number of digits for the random number should be sufficient to allow ignoring the probability for duplicate numbers). This is because the randomly generated ID number cannot be detected by humans, especially by strangers, and it enhances the security level of the container.

St405 and st406 are the steps for generating the network graph matrix. In st405, the communications nodes communicate among themselves with the other nodes and memorize a HOP number table that defines the distance between all of the other communication nodes.

One way to detect the distance from one communication node to the other nodes discussed above is disclosed in U.S. Pat. No. 6,028,857, of a communication network provided with a self-organizing network. This self-organizing network is a kind of relay system to communicate between a plurality of communication nodes, each of which has a low-power transmitter for saving battery power. This low-power transmitter can communicate only with neighboring nodes that are located only a few meters away for the purpose of saving battery power. The details will be explained in the flow chart which will be explained later. When node 1 wishes to communicate with node x which is located out of the communication range of the low-power transmitter, node 1 can send it's message to the neighboring nodes with a message of “forward my message to node x if you can do so within fewer than 4 HOPs”. Here, the “HOP” is defined as a relaying times to relay the message before the message finally reaches the destination node. If the neighboring nodes which received the message from node 1 are the ones who know they can forward the message to node X within the requested HOP number (times of relaying), they will forward or relay the message again to the neighboring nodes after they subtract 1 from the received HOP number. This relaying process will be continued until the message reaches node x. In this relay system, each node has a table which indicates the relaying number (HOP number) to send the message to each of the other nodes. For example, for sending a message from node 1 to node 2 requires HOP 3, to node 3 HOP 5, to node 4 HOP 2 etc. In other words, the HOP number table is defined by HOPs which are the relaying times between each of the nodes. This HOP number table will stay unchanged according to the above patent unless it is renewed by a so-called flood message.

We added the following functions to the above prior art technology. After the HOP number table is created in st405, each communication node collects all of the HOP number tables from the other nodes to create the network graph matrix in st406. In other words, all communication nodes will obtain the same network graph matrix, and this arrangement will enhance the security level, because it is more difficult to illegally alter the graph matrix memorized in each node.

In st407, the initial network graph matrix is memorized by each of the communications nodes. This initial network graph matrix will be a base data to be compared with the matrix data obtained at a later time. In st408, the surveillance system according to this invention will generate the network graph matrix at a predetermined interval so that the surveillance system can periodically monitor the status of the object to be monitored, such as the inside of the container. This st408 is a same step as st405 and st406 discussed above. In st409, each communications node detects differences between the initial network graph matrix of st407 and the generated network graph matrix of st408. If there is a difference between the initial and the generated matrix, the difference is recorded in the time array by each communications node. Then in st410, each communications node collects the difference data detected by the other communications nodes, and if it is determined to be a mistake in terms of its own majority logic, an error message is generated with its own node ID attached, which is transmitted to the other communications nodes and the node's own difference data record is corrected with the correct data difference. This step will be taken not only to ensure the data of the error messages, but also to protect the memory function of memorizing the history data by holding the same data by each of all of the communication nodes. Above steps are repeated periodically as checked in st411.

Processing in Each Communication Node

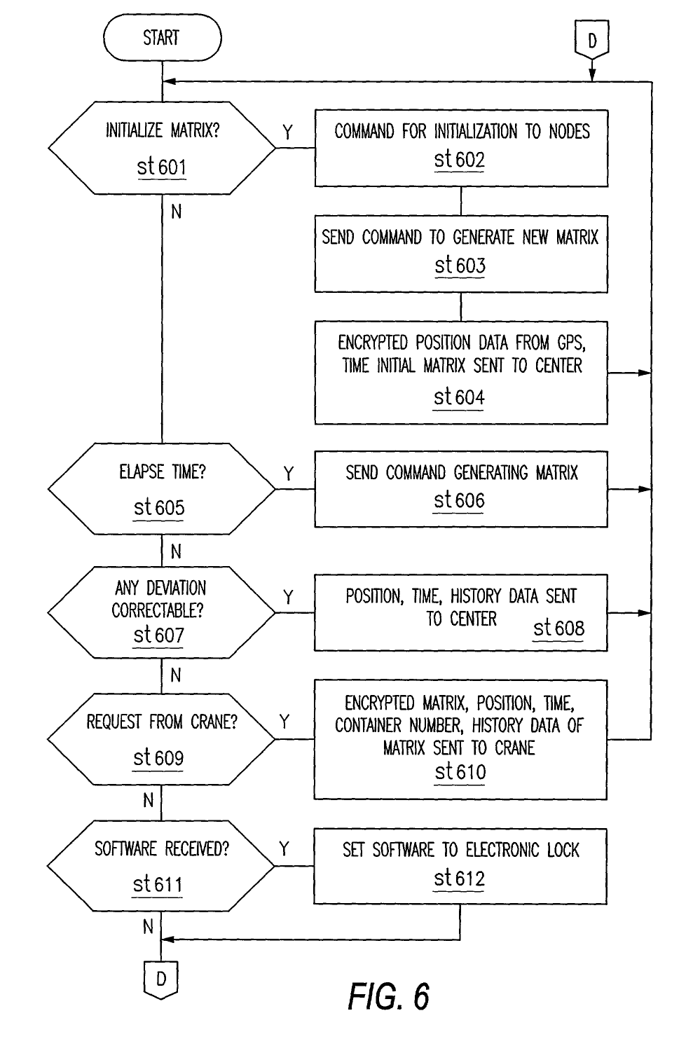

FIG. 5 is a process flow in each communication node in network 10 of this surveillance system 1000. In st501, if the node has no ID or if the node received the initialization request from control device 20, then in st502, the node will generate the ID by random number which has sufficient digits to allow ignoring the probability for duplicate numbers. In st503, the so-called “cost table” which indicates the Hop number to the other nodes from the node is generated. The method of obtaining such a cost-table is disclosed in U.S. Pat. No. 6,028,857 in detail. The basic concept of this patent is to use a so-called flooding message in order to detect the message relaying time to all of the communication nodes from each node. With this flooding message, each node will know the minimum relaying times to transmit it's own message to all of the other communication nodes by using a relatively weak signal which can only transmit the message to neighboring nodes, but can save the battery energy of the transmitter.

If No at st50l, then it is checked at st504 if the initialization request from the control device 20 is received. If Yes, then at st505 each node receives each “cost table” from each node, and also each node sends it's own “cost table” to all of the other nodes, so that, at st506, all other nodes can establish the same network graph matrix at each node location. Since this step is executed at the time of initiation of the system, after the container has completely been loaded with the cargo, the network graph matrix 300 generated at this step is memorized as an initial network graph matrix which will then be the reference matrix to be compared with the matrix generated at the time of interval detection.

After the initiation of the system mentioned above, the surveillance system will start to detect the status of the container by establishing the network graph matrix. If such a request is received by each node in the system at st507, the current network graph matrix established at st508 is compared with the initial network graph matrix established at st506. If there is any deviation between the initial network graph matrix and the current network graph matrix, the node or the control device 20 will record the deviation each time it detects such an event.

In the comparison process at st508, if there is a serious deviation which can be understood as an illegal entry to the container, the following preventive countermeasures will be taken.

1) Each communication node can delete the network graph matrix (the original and current ones)

2) The communication node will send a request to the other nodes to delete the same.

3) Each communication node will follow the request to delete the matrix sent from another node in the system.

The serious deviation is defined in the case where the communication between the nodes cannot be established at more than a predetermined percentage, more than a predetermined count in the matrix, or in which a node cannot communicate with any other nodes in the system.

In order to avoid the miss-detection of a deviation at each node, at st509 each node can compare the matrix data which is owned by the neighboring nodes, and can be corrected according to the majority logic.

Processing in the Control Device

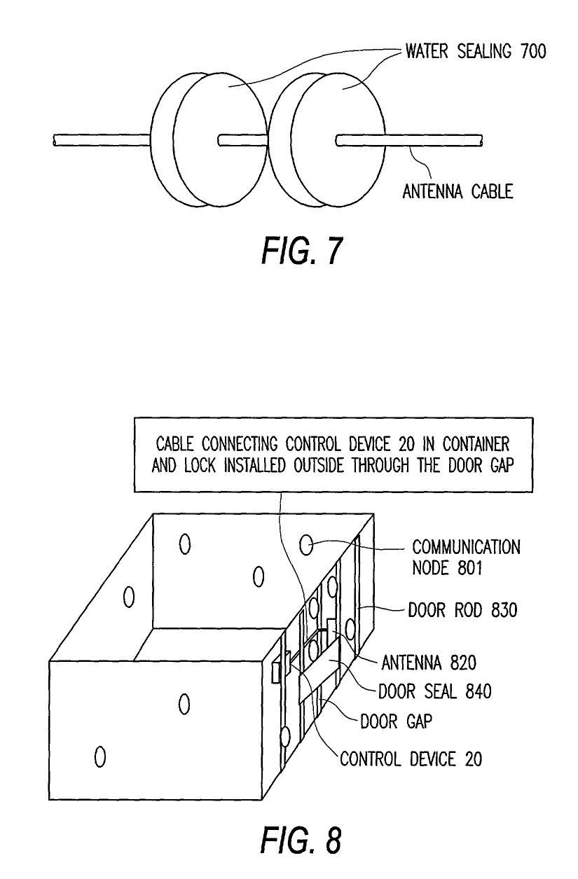

FIG. 6 is a process flow in control device 20 showing how the control device communicates with other devices outside of the container in surveillance system 1000 according to this invention. At st601, when control device 20, receives a message to initialize the network graph matrix in the surveillance system 1000, at st602 the control device 20 will send a command to the communication nodes to do so. The control device 20 then sends the command to the nodes to generate a new initial network graph matrix at st603, and obtains it from the nodes and sends the encrypted data to the monitoring control center 30 along with the position data transmitted from GPS receiver 40 and the time data at st604.

At st601, if the control device 20 did not receive the message to initialize the initial network graph matrix 300 at st601, and if the predetermined interval time has elapsed at st605, then control device 20 sends the command to the communication nodes to generate the current network graph matrix at st606. These steps will be repeated periodically for surveying the inside of container 1.

At st607, if the deviation between the previous and current network graph matrix ,which] cannot be corrected by the majority logic, then the control device will detect whether or not any real changes, such as the fact that the door was opened, or somebody entered the container, etc., have occurred. This fact is recorded as history data and sent to the monitoring control center 30 along with the position of the container obtained from GPS receiver 40 and the time data at st608. This step will be repeated each time such status occurs in container 1 so that this surveillance system can monitor the container any time until arrival at the destination.

At st609, for example, when container 1 arrives at the destination harbor, and is ready to be lifted up by the crane at the container yard, the crane requests the control device to transmit the encrypted history data to monitoring control center 30 in order to confirm if there was a deviation of the container status during the traveling time between the shipping out location and the destination at st609 and st610. If the monitoring control center 30 confirms that there was no deviation of the container status, and the security of the container is confirmed, then monitoring control center 30 will send the software for opening the electronic lock system 60 to the control device 20 at st611, and the software will be installed in the electronic lock system 60 by control device 20 at st612. The consignee or custom officers will receive the password from monitoring control center 30 through a separate safety route that is guaranteed for security, and the container is now ready to be opened after the security is guaranteed. The separate safety route is, for example, E-mail, or other separate communication route separate from this system.

Effect of the Invention

Since the inside-seals for sealing a container according to this invention are provided in the container, nobody can observe them from the outside. This arrangement can prevent terrorists pre-arranging the illegal opening and closing a door of the container, or freezing the electronic circuit to fool the detection function for detecting opening and closing the door.

Since the communication nodes of the inside-seal are provided basically at the random positions in a container. This makes it more difficult for the illegal operators, or terrorists to fool the surveillance system.

The password for opening and closing a door according to this invention is automatically generated at a surveillance center which is separated from the container operating companies. This arrangement can prevent the password from being leaked by the illegal operators.

Since the electronic fingerprint is randomly generated, it will be no more possible to regenerate the identical one. When terrorists prepare a bogus container to swap with a true container, it is no more possible to copy the true password because the true password has been deleted.

Not only detecting the illegal opening or closing the door, the surveillance system according to this invention can detect a fact the dangerous materials have been inserted through a hole made by a drill, burner, or laser beam by providing the sensors on the wall of a container:

Since the surveillance system according to this invention makes it possible to detect such illegal loading into the container by transmitting the detecting signals obtained through self-organizing communication network provided between a plurality of containers loaded on the container ship, it is possible to prevent dangerous containers from entering into the USA, before they enter into the USA, maybe during the transportation by a container ship. The surveillance center can, therefore, notify such a fact to the coast guard before the container arrives to the destination port.

What is claimed is:

1. A status surveillance system to survey an object status in a predetermined space by a communication status data, comprising:
one or more communication devices having a wireless communication capability of communicating with a plurality of communication nodes randomly installed in said predetermined space;
an information collecting means to collect communication data from said plurality of nodes; and
a status information generating means to generate a status information of said object based on a communication distribution data obtained by said communication data from said plurality of nodes.

2. A status surveillance system according to claim 1, wherein said status information generating means generates said status information of said object to be surveyed using a totality of said communication data, or only a characteristic portion of said communication data.

3. A status surveillance system according to claim 1, further comprising:
an initial status recording means to record an initial status information of said object to be surveyed, which is generated by said status information generating means; and
a comparison means to compare a current status information of said object, which is generated by said status information generating means at a predetermined time interval, with said initial status information recorded in said initial status recording means, and output the comparison result.

4. A status surveillance system according to claim 3, wherein, when a deviation resulting from said comparison between said current status information and said current status information is more than a predetermined range, or said comparison itself is not possible to execute, or a communication with the other communication nodes is not possible, then said status surveillance system judges whether or not there is an abnormality in said object to be surveyed, and deletes said status information recorded in each communication device if said status information is already recorded in a surveillance center.

5. A status surveillance system according to claim 1, further comprising an information transmitting means to transmit an initial status information of said object and a current status information at a predetermined time interval, which are generated by said status information generating means, to a surveillance center which is located at a remote location from said object to be surveyed.

6. A status surveillance system according to claim 5, wherein, when a deviation resulting from said comparison between said current status information and said current status information is more than a predetermined range, or said comparison itself is not possible to execute, or a communication with the other communication nodes is not possible, then said status surveillance system judges there is an abnormality in said object to be surveyed, and deletes said status information recorded in each communication device if said status information is already recorded in said surveillance center.

7. A status surveillance system according to claim 3, further comprising a sensor device provided in each communication node to detect the local status of a neighboring space around said communication node, wherein said status surveillance system judges there is an abnormality in said object if said sensor device outputs an abnormal local status signal.

8. A status surveillance system according to claim 3, wherein said sensor device is a vibration sensor to detect a vibration of said object to be surveyed, a temperature sensor to detect the temperature of said object, any type of sensors to detect an invasion from outside of said predetermined space provided with said object.

9. A status surveillance system to survey an inside status of a cargo container by a communication status data, comprising:
one or more communication devices having a wireless communication capability to communicate with a plurality of communication nodes randomly installed in said container;
an information collecting means to collect communication data from said plurality of nodes;
a status information generating means to generate a status information of said container based on a communication distribution data obtained by said communication data from said plurality of nodes;
an initial status recording means to record an initial status information of said container to be surveyed, which is generated by said status information generating means;
a comparison means to compare a current status information of said container, which is generated by said status information generating means at a predetermined time interval, with said initial status information recorded in said initial status recording means, and output of the comparison result; and
a surveillance center to receive said comparison result from said comparison means, wherein, if said comparison result from said comparison means is more than a predetermined deviation, then said surveillance center sends a warning signal to an unloading crane to handle said container with special attention.

10. A status surveillance device to be installed in a freight container to survey the inside status of said container by a communication status data, comprising:
one or more communication units having a wireless communication capability to communicate with a plurality of communication nodes randomly installed in said container;
an information collecting means to collect communication data from said plurality of nodes; and
a status information generating unit to generate a status information of said container based on a communication distribution data obtained by said communication data from said plurality of nodes.

11. A status surveying method to survey an inside status of a cargo container by a communication status data, comprising the steps of:
collecting communication data from said plurality of nodes randomly installed in said container
generating a status information of said container based on a communication distribution data obtained by said communication data from said plurality of nodes;
recording an initial status information of said container;
comparing a current status information of said container, which is generated at a predetermined time interval, with said initial status information and outputting the comparison result; and
judging whether or not said container is safety base on said comparison result.

What is claimed is:

1. A status surveillance system to survey an object status in a predetermined space by a communication status data, comprising:
one or more communication devices having a wireless communication capability of communicating with a plurality of communication nodes randomly installed in said predetermined space;
an information collecting means to collect communication data from said plurality of nodes; and
a status information generating means to generate a status information of said object based on a communication distribution data obtained by said communication data from said plurality of nodes.

2. A status surveillance system according to claim 1, wherein said status information generating means generates said status information of said object to be surveyed using a totality of said communication data, or only a characteristic portion of said communication data.

3. A status surveillance system according to claim 1, further comprising:
an initial status recording means to record an initial status information of said object to be surveyed, which is generated by said status information generating means; and
a comparison means to compare a current status information of said object, which is generated by said status information generating means at a predetermined time interval, with said initial status information recorded in said initial status recording means, and output the comparison result.

4. A status surveillance system according to claim 3, wherein, when a deviation resulting from said comparison between said current status information and said current status information is more than a predetermined range, or said comparison itself is not possible to execute, or a communication with the other communication nodes is not possible, then said status surveillance system judges whether or not there is an abnormality in said object to be surveyed, and deletes said status information recorded in each communication device if said status information is already recorded in a surveillance center.

5. A status surveillance system according to claim 1, further comprising an information transmitting means to transmit an initial status information of said object and a current status information at a predetermined time interval, which are generated by said status information generating means, to a surveillance center which is located at a remote location from said object to be surveyed.

6. A status surveillance system according to claim 5, wherein, when a deviation resulting from said comparison between said current status information and said current status information is more than a predetermined range, or said comparison itself is not possible to execute, or a communication with the other communication nodes is not possible, then said status surveillance system judges there is an abnormality in said object to be surveyed, and deletes said status information recorded in each communication device if said status information is already recorded in said surveillance center.

7. A status surveillance system according to claim 3, further comprising a sensor device provided in each communication node to detect the local status of a neighboring space around said communication node, wherein said status surveillance system judges there is an abnormality in said object if said sensor device outputs an abnormal local status signal.

8. A status surveillance system according to claim 3, wherein said sensor device is a vibration sensor to detect a vibration of said object to be surveyed, a temperature sensor to detect the temperature of said object, any type of sensors to detect an invasion from outside of said predetermined space provided with said object.

9. A status surveillance system to survey an inside status of a cargo container by a communication status data, comprising:
one or more communication devices having a wireless communication capability to communicate with a plurality of communication nodes randomly installed in said container;
an information collecting means to collect communication data from said plurality of nodes;
a status information generating means to generate a status information of said container based on a communication distribution data obtained by said communication data from said plurality of nodes;
an initial status recording means to record an initial status information of said container to be surveyed, which is generated by said status information generating means;
a comparison means to compare a current status information of said container, which is generated by said status information generating means at a predetermined time interval, with said initial status information recorded in said initial status recording means, and output of the comparison result; and
a surveillance center to receive said comparison result from said comparison means, wherein, if said comparison re-suit from said comparison means is more than a predetermined deviation, then said surveillance center sends a warning signal to an unloading crane to handle said container with special attention.

10. A status surveillance device to be installed in a freight container to survey the inside status of said container by a communication status data, comprising:
one or more communication units having a wireless communication capability to communicate with a plurality of communication nodes randomly installed in said container;
an information collecting means to collect communication data from said plurality of nodes; and
a status information generating unit to generate a status information of said container based on a communication distribution data obtained by said communication data from said plurality of nodes.

11. A status surveying method to survey an inside status of a cargo container by a communication status data, comprising the steps of:
collecting communication data from said plurality of nodes randomly installed in said container generating a status information of said container based on a communication distribution data obtained by said communication data from said plurality of nodes;
recording an initial status information of said container;
comparing a current status information of said container, which is generated at a predetermined time interval, with said initial status information and outputting the comparison result; and
judging whether or not said container is safety base on said comparison result.
